(19) United States
(12) Patent Application Publication
(10) Pub. No.: US 2013/0334232 A1
(43) Pub. Date: Dec. 19, 2013

(54) WELDED SEALING OF PRESSURE CYLINDER VESSEL

(71) Applicant: Mats Gärdin, Vasteras (SE)

(72) Inventor: Mats Gärdin, Vasteras (SE)

(73) Assignee: Avure Technologies AB, Vasteras (SE)

(21) Appl. No.: 13/978,180

(22) PCT Filed: Jan. 7, 2011
(86) PCT No.: PCT/EP2011/050165

§ 371 Date: Sep. 9, 2013

(51) Int. Cl. F17C 1/04

(52) U.S. Cl. CPC F17C 1/04
USPC 220/592

(57) ABSTRACT

A pressure vessel for isostatic pressing and a press comprising such a pressure vessel, wherein the pressure vessel comprises at least two sub-cylinders which are axially connected to form a force absorbing pressure vessel cylinder for enclosing a pressure medium during said isostatic pressing, wherein the axially connected sub-cylinders are welded along the joint(s) of the connected sub-cylinders. The pressure vessel comprises axially pre-stressing means arranged for exerting axial compressive forces on the sub-cylinders for attaining axial compressive stress at said joint(s) when the pressure medium is pressurized, and radially pre-stressing means arranged for exerting radial compressive forces on the sub-cylinders for attaining tangential compressive stress at the joint(s) when the pressure medium is pressurized.

### FIELD OF THE INVENTION

The present invention relates to the field of high pressure pressing. In particular, the present invention relates to a pressure vessel for isostatic pressing. Also, the invention relates to a high-pressure press for isostatic pressure treatment of articles which uses such a pressure vessel.

### BACKGROUND OF THE INVENTION

Isostatic presses are used in producing different types of articles, such as turbine blades for aircraft or artificial hip joints for implantation into persons. The press usually comprises a furnace provided with electric heating elements for increasing the temperature in the furnace chamber where the load, i.e. the articles, is being pressed in a loading space. After a finished pressing operation it is often important to rapidly cool the loading space so that the load therein will obtain the desired properties and so that grain growth is avoided or minimized. Furthermore, rapid cooling results in increased productivity since the load may be removed rapidly, thereby reducing the cycle time. However, it is also important that an even cooling throughout the loading space is achieved.

During a high-pressure pressing operation of a high-pressure press, a pressure medium, which is accommodated in a pressure chamber of a pressure vessel, is pressurized to a very high pressure. The pressure medium is often a fluid gaseous medium. High-pressure presses can be used in various applications. A high-pressure press can for example be used for forming of sheet metal parts into predetermined shapes by highly pressurizing a fluid provided in a closed pressure vessel and use as an exerting force onto an intermediate diaphragm or the like. If the high-pressure press exerts an equal pressure on every side of the contents in the pressure vessel, the press is called an isostatic press. Isostatic presses can be used for compaction or densification of metallic or ceramic powders, for reduction of pores or voids in castings or sintered articles, for sterilization and preservation of food stuffs, etc. Depending on the temperature of the pressure medium during an isostatic pressing process, the process can be called a hot isostatic pressing or a HIP (hereinafter referred to as HIP), warm isostatic pressing or cold isostatic pressing (hereinafter referred to as CIP).

A pressure vessel of a conventional high-pressure press comprises a pressure vessel cylinder. The pressure vessel cylinder is closed by closure lids at the cylinder ends thereby enclosing the pressure chamber which is filled with the pressure medium. A frame is arranged to absorb axial loads.

To increase the ability of the pressure vessel to resist crack formation and propagation, the pressure vessel is commonly pre-stressed. The vessel can for example be pre-stressed by autofrettage, by shrinkage or by wire-winding of the pressure vessel cylinder.

The pressure level in the pressure vessel depends on the press type and the material to be pressed. In sheet metal forming, the press is typically designed for pressures up to 140 MPa, in CIP for between 100 MPa and 600 MPa and in HIP for up to 300 MPa.

A cylinder for a high pressure press is traditionally manufactured by forging. A body is first casted and subsequently forged to form a pressure vessel cylinder. After a heat treatment the pressure vessel cylinder is machined into its final shape and dimension. To manufacture very large cylinders put high demands on the equipments for the forging-, heat treatment- and machining processes.

Recently the demand for larger and larger sizes of the articles to be pressed has increased, implying a demand for larger and larger presses. One alternative way of producing larger presses is the manufacturing of pressure vessels with a pressure vessel cylinder comprising axially connected sub-cylinders. The pressure vessel cylinder can then comprise two or more sub-cylinders arranged in connection with each other, whereby the dimension (axial length) of the pressure vessel cylinder of the isostatic press is not limited by the manufacturing process of one single large cylinder. Not only large presses would benefit from a pressure vessel cylinder comprising connected sub-cylinders. Also smaller pressure vessels would benefit from such a construction, for example, it may be possible to obtain a shorter time of delivery. However, there are problems related to such constructions. For example, the construction must withstand very high pressures without dangerous leakage or pressure vessel failure, which entails that it is crucial that the joints between connected sub-cylinders are sealed and that the sealing is capable of sustaining these high pressures also over time. Further, it is also important to hold the sub-cylinders together during the manufacturing process or forming process when the sub-cylinders are joined to a pressure vessel. In addition to the above, the construction of the HIP must also withstand high temperatures.

Hence, there is a need within the art of improved pressure vessels for HIP and CIP that alleviates at least some of the above-mentioned problems.

### SUMMARY OF THE INVENTION

An object of the present invention is to provide a pressure vessel for isostatic pressing and a high-pressure press for isostatic pressure treatment of articles which alleviate at least some of the above mentioned problems.

This object, which will become apparent in the following, are achieved by a pressure vessel hot isostatic pressing and a high-pressure press as claimed in the independent claim. Preferred embodiments are defined in the dependent claims

According to a first aspect of the present invention, there is provided a pressure vessel for isostatic pressing which comprises at least two sub-cylinders welded along the joint(s), axially pre-stressing means and radially pre-stressing means. The at least two sub-cylinders are axially connected to form a force absorbing pressure vessel cylinder for enclosing a pressure medium during said isostatic pressing. The sub-cylinders are connected together end-to-end which thereby forms a longer pressure vessel cylinder such that the cylinder space, which is defined by the inner wall of the sub-cylinder, is extended in the direction of the cylinder axis of the cylinder. The resulting pressure vessel cylinder of connected sub-cylinders encloses a space which is filled with a pressure medium during the isostatic pressing. It is understood that the resulting cylinder is closable at its open ends by closing lids thereby enclosing a pressure chamber. The axially connected sub-cylinders are welded or brazed or soldered along the joint(s) of the connected sub-cylinders. The axially pre-stressing means is arranged for exerting axial compressive forces on the sub-cylinders for attaining axial compressive stress at said joint(s) when the pressure medium is pressurized. In other words, during the isostatic pressing when the pressure medium is pressurized the axially pre-stressing means exerts axially directed compressive forces on the sub-cylinders resulting in compressively stressed joint(s) in the axial direction. The radially pre-stressing means arranged for exerting radial compressive forces on the sub-cylinders for attaining tangential compressive stress at the joint(s) when the pressure medium is pressurized. Thus, during the isostatic pressing when the pressure medium is pressurized the radially pre-stressing means exerts radially directed compressive forces on the sub-cylinders resulting in compressively stressed the joint(s) in the tangential direction.

According to a second aspect of the present invention, there is provided a high-pressure press for isostatic pressure treatment of articles, comprising a pressure vessel according to the first aspect of the invention, including a force-absorbing press frame provided around the pressure vessel pressure vessel cylinder.

The present invention is based on the insight that a pressure vessel comprising axially connected sub-cylinders being pre-stressed in both the axial direction and the radial direction, when the pressure vessel is pressurized, enables a welded or brazed interconnection along the joint(s) of the connected sub-cylinders, i.e. the joint is welded or brazed. Thus, by welding or brazing along the joint(s) connected sub-cylinders having a fluid-tight seal at the joint(s) can be obtained. When the pressure vessel is pressurized, the relative, i.e. relative to each other, movement of the oppositely arranged sub-cylinder ends of the connected sub-cylinders is negligible due to the axially and radially pre-stressing. More specifically, the relative position of the respective end surfaces which are in contact with each other of the connected sub-cylinder ends are forced to maintain its position relative the opposite surface by means of the pre-stressing means.

During operation of the pressure vessel, the axially pre-stressing means exerts axially directed forces on the sub-cylinders of the pressure vessel cylinder for achieving a compression of the connected sub-cylinders, i.e. the axial forces is directed inwardly towards the joint(s) such that the sub-cylinders are axially compressed together. However, the joint between the sub-cylinders can be affected by a separating force exerted by the pressurized medium. This axially directed, separating force acts to separate the sub-cylinders. Thus, the pre-stressing means is arranged to counteract this separating force and is further sufficiently large enough to completely counteract and neutralize the separating force such that the resulting force is a compressive force. In other words, the axially pre-stressing means is a means for axially pre-stressing the axially connected sub-cylinders such that they are compressed together and wherein the axially pre-stressing means generates forces large enough to compensate for a separating force exerted by the pressurized medium. As a result, the joint between the sub-cylinders is in a compressive state, i.e. the ends of the sub-cylinders are compressed together. In turn, this result in that weld is free from axially directed tensile stress. Furthermore, since the pressure vessel cylinder is radially pre-stressed, even when the pressure vessel is pressurized, the weld is also essentially free from tangentially directed tensile stress. Consequently, the weld is free from tensile stress in all direction when the pressure vessel is axially and radially pre-stressed when the pressure medium is pressurized.

As mentioned above, due to the welding, soldering or brazing, the connection is a fluid-tight seal which prevents leakage of the pressure medium through the joint(s) of the connected sub-cylinders.

The connection can also withstand high temperatures. A pressure vessel of axially connected sub-cylinders according to the present invention is advantageously used in high-temperature applications, such as a HIP. During operation of emptying the pressure chamber of fluid, such as during the operation of a HIP, the sealing will prevent fluid outside the chamber to leak into the pressure chamber which increases efficiency of a vacuum cycle. Consequently, the connection provides a bidirectional sealing resulting in a leak-proof joint in both directions, i.e. from the chamber to the outside and vice versa.

Another advantage of using a welded or brazed connection as a sealing at the joints is that the pressure vessel can be radially pre-stressed by means of a one-piece pre-stressing means, i.e. the connected sub-cylinders acts as a one-piece pressure vessel. No separate pre-stressing means for each sub-cylinder is needed.

Furthermore, a pressure vessel which comprises axially connected sub-cylinders which are welded together along the joints permit larger vessels compared with one-piece vessels since each of the sub-cylinders can be manufactured separately. If the pressure vessel is assembled locally at the press operation site, a pressure vessel cylinder formed by separate sub-cylinders enables an easy transportation thereof due to smaller pieces.

According to an embodiment of the present invention, the axially pre-stressing means comprises at least one pair of axially pre-stressing surfaces provided on either side of the joint(s) for taking up axial forces exerted thereon when the pressure medium is pressurized, and wherein the axially pre-stressing surfaces are arranged for transferring said axial forces via the wall of sub-cylinder to the joint(s) such that an axial compressive stress at said joint(s) is attained. The first and second surfaces of the two surfaces of the pair of axially pre-stressing surfaces are provided on either side of the joint(s). The two axially pre-stressing surfaces of the pair are thus arranged on either side of the joint(s), i.e. a first axially pre-stressing surface on one side and a second axially pre-stressing surface on the other, opposite side of the joint(s). Both the first and the second axially pre-stressing surfaces are arranged for taking up axial forces exerted thereon when the pressure medium is pressurized. Furthermore, the axially pre-stressing surfaces are arranged for transferring the axial forces exerted thereon via the wall of sub-cylinder, i.e. through the cylinder wall, to the joint(s) of the pressure vessel cylinder. Thereby, the transferred forces attain axial compressive stress at the joint(s). More specifically, the first and second surfaces of the pair of axially pre-stressing surfaces are arranged for transferring the axial forces exerted thereon towards each other in the axial direction. In other words, each of the first and second axially pre-stressing surfaces of the pair axially transfer the forces exerted thereon in an axial direction inwardly towards the joint(s) in between the pair.

In one embodiment the axially pre-stressing means comprises only one pair of axially pre-stressing surfaces, and wherein a first and second surface of the pair of the axially pre-stressing surfaces are arranged on a first and second end sub-cylinders, respectively, such that the joint(s) is(are) situated in between the pair of axially pre-stressing surface. In this case, all joint(s) are compressed together by the pair of axially pre-stressing surfaces which are arranged on either side of the joint(s). In the case where a pressure vessel cylinder has a plurality of axially connected sub-cylinders, it is understood that the pressure vessel cylinder has two end sub-cylinders which are the respective outermost sub-cylinders at each side of the cylinder, i.e. the two opposite sub-cylinders at respective end of the cylinder.

In a further embodiment, the first axially pre-stressing surface is arranged on an inner wall of the first end sub-cylinder and the second axially pre-stressing surface is arranged on an outer wall of the second end sub-cylinder, such that the first axially pre-stressing surfaces takes up internal, axial forces by the pressure medium when the pressure medium is pressurized and the second outer surface takes up external, axial forces by means of an external force outside the pressurized volume. The outer wall is a portion of the wall which is not in contact with the pressure medium in the pressure chamber inside the pressure vessel, thus it should be noted that the term “outer wall” as used herein is intended to refer to a cylinder wall portion which is not in contact with the pressure medium during the pressing. In this case the first axially pre-stressing surface transfers an axial force, due to the pressurized pressure medium, via an inner wall portion of the sub-cylinder wall to the joint(s). The second axially pre-stressing surface transfers an axial force via an outer wall portion of the sub-cylinder wall to the joint(s).

In an alternative embodiment, the axially pre-stressing surfaces are arranged on an outer wall of the sub-cylinders, such that the axially pre-stressing surfaces take up external, axial forces by means of an external force outside the pressure vessel. Thereby the axially connected sub-cylinders are axially pre-stressed by means of external forces only.

In yet another alternative embodiment, the axially pre-stressing surfaces are arranged on an inner wall of the sub-cylinders. Thereby, the axially connected sub-cylinders are axially pre-stressed by means of the pressurized pressure medium only.

In a further embodiment of the present invention, the axially pre-stressing means comprises one pair of axially pre-stressing surfaces for each joint(s), and wherein the axially pre-stressing surfaces are arranged on an inner wall of the sub-cylinders, such that each of the axially pre-stressing surfaces takes up forces exerted by the pressure medium when the pressure medium is pressurized. Thereby, each joint is individually compressed by an individual pair of axially pre-stressing surfaces. All intermediate sub-cylinder, i.e. all sub-cylinder in between the end sub-cylinders which are only in contact with another sub-cylinder in one end, are thereby arranged with two axially pre-stressing surfaces, one for each joint of the respective two connectable ends of the sub-cylinder.

According to an embodiment of the present invention, the axially pre-stressing surface is an annular surface on an annular shoulder which is arranged on the inner cylinder wall of the sub-cylinder. Thereby the sub-cylinder is provided with an annular shoulder which is arranged on the inner wall. The shoulder comprises an annular surface which constitutes the axially pre-stressing surface. It is understood the axial position of the shoulder on the inner wall is optional as long as it can transfer an axially directed force towards the joint. For example, the shoulder can be arranged at the joint or at the other side of the sub-cylinder far away from the joint.

In one embodiment, the sub-cylinders are in contact via an annular contact surface at the joint(s), and wherein the annular contact surface has a radial extension which is less than that of the annular surface of the axially pre-stressing surface. The sub-cylinders in contact with each other of the connected sub-cylinders are in contact via a common contact surface along the respective cylinder wall ends of the two sub-cylinders which are connected to each other. It understood that the annular contact surface follows the circular shape of the cylinder wall end. It is also understood that the contact surface is equal to the common surface which the two cylinder wall ends contact each other. For example, the respective cylinder wall ends may have different annular end surfaces with regards to size and shape, but the annular contact surface is the surface where they are in contact. In the case where one cylinder wall end is thin and the other thick, the annular contact surface is defined by the thin cylinder wall end, on condition that the thinner wall end extends within the area of the thicker wall end. Moreover, the annular contact surface has a radial extension which is equal or less than that of the annular surface of the axially pre-stressing surface, resulting in that the axially pre-stressing surface has an equal or longer radial extension. It is understood that by the term “radial extension” as used herein is intended to refer to the extension of the diameter of the outer periphery of the annular surface, i.e. the diameter of the outer periphery of the annular contact surface is at least not larger than that of the annular surface of the axially pre-stressing surface. As a result, the area of the axially pre-stressing surface is equal or larger than that of the annular contact surface. Any separating force in the axial direction which is exerted on the joint when pressurized pressure medium pressurizes the join is thereby at least compensated. Furthermore, if the area of the axially pre-stressing surface is larger than that of the annular contact surface then the separating force in the axial direction will be over-compensated for. An over-compensated joint(s) ensures a joint(s) which is in a compressed state.

In a further embodiment of the present invention, at least one end of a first and second connected sub-cylinder ends at the joint(s) has a tapered cylinder wall end provided with an annular end surface in contact with the other sub-cylinder end of the first and second connected sub-cylinder ends, such that said annular end surface of the tapered cylinder wall end defines said annular contact surface which the sub-cylinders are in contact at the joint(s). Thereby, a well-defined contact surface is achieved which enables the joint(s) to be in a compressively stressed state when the pressure medium is pressurized.

According to an embodiment of the present invention, the tapered cylinder wall is an annular protrusion at the inner cylinder wall. Thereby, an annular space laterally outside the protrusion is achieved which enables, for example, leaking pressure medium to be guided such that the leakage could be indicated and detected.

In an embodiment of the present invention, the radially pre-stressing means is provided around the envelope surface of the pressure vessel cylinder. The radially pre-stressing means can be provided around the entire envelope surface of the pressure vessel cylinder in one piece, in that respect that its means is not divided into separate means for separate cylinder portions.

In one embodiment of the present invention, the axially connected sub-cylinders are welded along the joint(s) on the inner wall of the sub-cylinders.

According to embodiments of the present invention, each of the sub-cylinders comprise one or several cylinder segment/segments arranged to form a pressure vessel cylinder surrounding the pressure chamber, whereby a joint is formed at adjacent longitudinal edges of the cylinder segment/segments. That is, the cylinder segment or segments form/-s the sub-cylinder. This is described thoroughly in the co-pending application “Pressure vessel and high-pressure press” by the same applicant, which hereby is incorporated herein by reference. Each joint at adjacent edges of the cylinder segment or segments have a continuous extension along the longitudinal length of the pressure vessel cylinder. The cylinder segments are in some embodiments held together by the prestressing band. However, in other embodiments, the segments can be fixed together at the joints with various methods, depending for example on the material of the force absorbing cylinder. If the segments comprise a metal material, the segments are preferably welded together with an arbitrary welding technique. Gluing is another alternative.

The features that characterize the invention, both as to organization and to the method of operation, together with further objects and advantages thereof, will be better understood from the following description which is used in conjunction with the accompanying drawings. It is to be expressively understood that the drawings is for the purpose of illustration and description and is not intended as definition of the limits of the invention. These and other objects attained, and advantages offered, by the present invention will become more fully apparent as the description that now follows is read in conjunction with the accompanying drawings.

### BRIEF DESCRIPTION OF THE DRAWINGS

FIG. 1 illustrates schematically a pressure vessel of an isostatic press according to an embodiment of the present invention.

FIG. 2 illustrates schematically a pressure vessel of an isostatic press according to another embodiment of the present invention.

FIG. 3 illustrates schematically a pressure vessel of an isostatic press according to a further embodiment of the present invention.

FIG. 4 illustrates a cross-sectional view of the pressure vessel of FIG. 3.

FIG. 5 illustrates schematically an embodiments of the present invention.

### DETAILED DESCRIPTION OF THE DRAWINGS

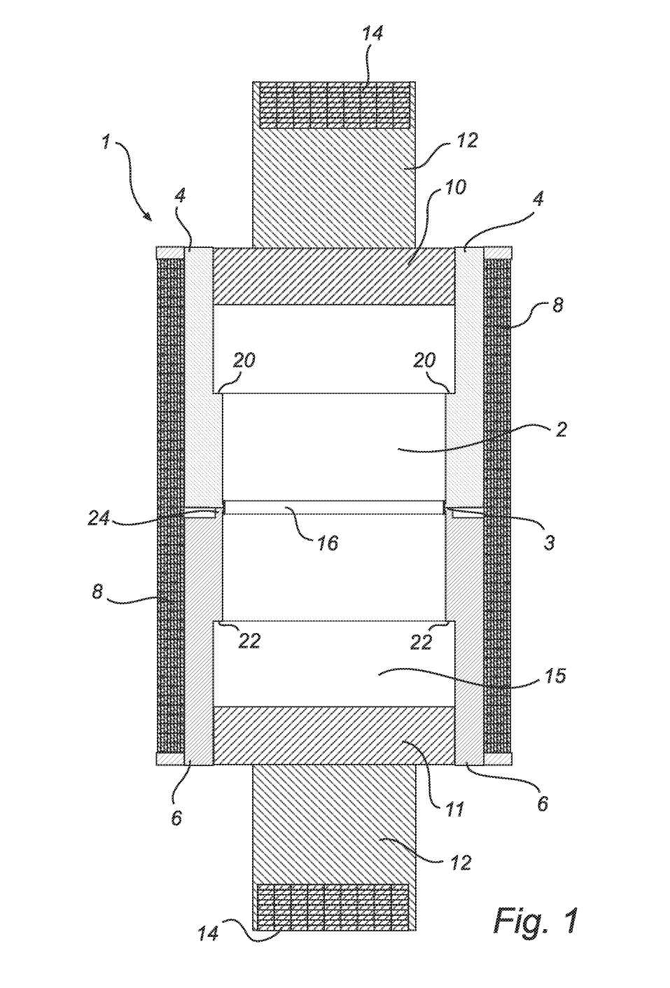

FIG. 1 is a schematic cross section view of a pressure vessel 1 according to one embodiment of the invention. The pressure vessel 1 comprises a pressure vessel cylinder 2 comprising two connected sub-cylinders 4, 6. The pressure vessel cylinder 2 is closed at the ends by lids 10, 11 which are held in place by a framework 12. The pressure vessel cylinder 2 together with end lids 10 and 11 encloses a pressure chamber 15, which is arranged to accommodate the articles together with the pressure medium.

The outer envelope surface of the pressure vessel cylinder 2 is provided with a pre-stressing means in the form of a package of wound steel bands 8. The bands are wound tightly tangentially around the envelope surface of the pressure vessel cylinder 2 to provide a radial compressive stress in the pressure vessel wall. The band is wound in a helical manner from one end of the cylinder to the other and back. The bands have a rectangular cross-sectional shape and are wound edge to edge. Each winding from one end to the other forms a separate pre-stressing layer, and the entire pre-stressing means comprise several layers of wound steel bands.

The framework 12 is also provided with a package of wound steel bands 14 to assist the framework 12 in taking up axial loads. To open the pressure vessel 1, the framework 12 is moved in the direction perpendicular to the axial direction of the cylinder body 2, whereby a lid 10, 11 can be removed giving access to the inner side, i.e. the pressure chamber, of the pressure vessel cylinder 2.

In the following, the connections between the sub-cylinders are described as being welded. However, the connections can also be obtained by brazing.

The two sub-cylinders 4, 6 are axially connected by a weld 16 running along the inner wall of the pressure vessel cylinder 2, thereby providing a sealing arrangement which seals a joint 3, i.e. where the sub-cylinders are connected and in contact with each other, between the two sub-cylinders 4, 6. Although not shown, it is understood that the weld 16 can extend into the pressure vessel cylinder 2. Thus, the two sub-cylinders 4 and 6 connects each other at the joint 3 along an annular contact surface, which is defined by an axially protruding cylinder portion 24 of the sub-cylinder 6. The protruding portion 24 is a wall portion innermost of the cylinder wall which protrudes from the cylinder wall end of the sub-cylinder 6. In other words, an innermost cylindrical portion of the cylinder wall of the sub-cylinder end facing the sub-cylinder 4 protrudes in the axial direction towards the sub-cylinder 4. This protruding cylinder portion 24 contacts sub-cylinder 4 along a common contact surface at the joint 3. Thus, the contact surface is defined by end surface of the protruding cylinder portion 24 which is in contact with the oppositely connected sub-cylinder 4.

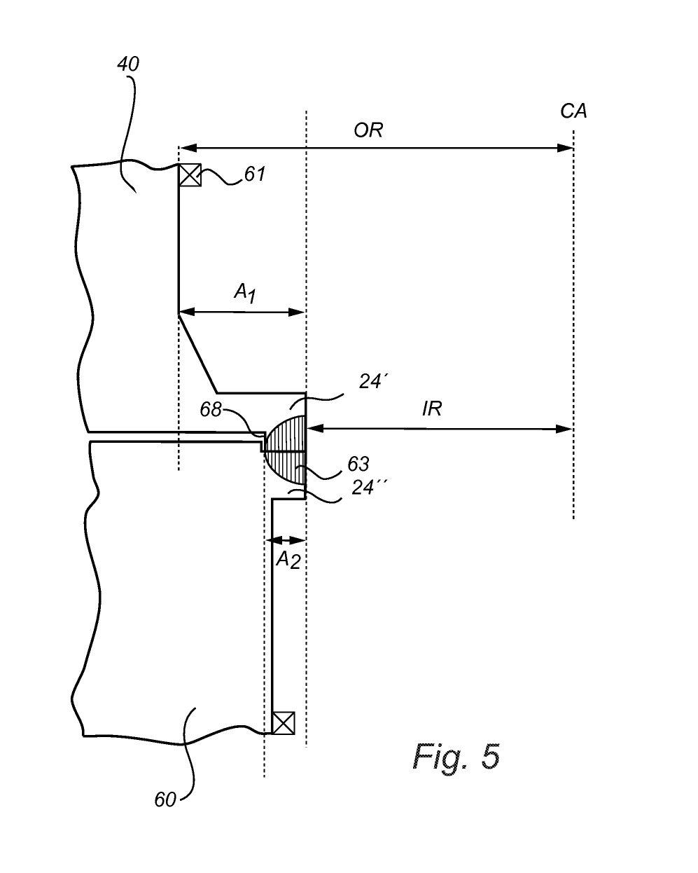

With reference to FIG. 5, the connection at the joint between the sub-cylinders will be discussed in more detail. FIG. 5 schematically illustrates an embodiment of the present invention. One of or both ends of the first and second sub-cylinders 40, 60 is provided with a contact surface formed as a step-like, annular end surface 24′ and 24″, respectively. The connected ends of the sub-cylinders 40, 60 are further arranged with a force-applying surface A1 and a force-bearing surface A2, respectively. The force-applying surface A1 is defined as a projection in an axial direction of surfaces of a sub-cylinder between an outer radius OR of an upper sealing 61 seen from a central axis CA of the pressure vessel 100 and an inner radius IR of the joint 63 interconnecting the sub-cylinders 40, 60. The force-bearing surface A2 is defined as projection in an axial direction of surfaces between the inner radius IR of the joint interconnecting the sub-cylinders 40, 60 and an outer surface 68 of the contact surface 24′. According to preferred embodiments of the present invention, A1 is equal to or larger than A2. If A1 is larger than A2, an average contact pressure between the surface 24′ and 24″, respectively, will be larger than an inner overpressure of the pressure vessel.

Furthermore, each sub-cylinder 4 and 6 of the pressure vessel 1 is provided with axially pre-stressing means by means of axially pre-stressing surfaces 20 and 22, respectively. These axially pre-stressing surfaces are annular surfaces along the inner wall of the two sub-cylinders 4 and 6. The axially pre-stressing surfaces are arranged for taking up axial forces exerted by the pressure medium when pressurized, such that the sub-cylinders are axially compressed. More specifically, the axially pre-stressing surfaces 20 and 22, respectively, take up an axial force which is exerted thereon by the internal pressure of the pressurized pressure medium. Thereby, the two sub-cylinders 4 and 6 are compressed together. Although not shown, when the pressure medium is pressurized, the joint 3 can be affected by axially separating forces which is also exerted by the pressurized pressure medium. In FIG. 1 the areas of the annular surfaces of the axially pre-stressing surfaces 20 and 22, respectively, are essentially equal. Also, each of these areas of the axially pre-stressing surfaces 20 and 22 are greater than the area of the contact surface at the joint, i.e. the annular contact surface has a radial extension which is here less than that of the annular surface of the axially pre-stressing surface. Since the area of the axially pre-stressing surfaces 20 and 22, respectively, is greater than that of the contact surface of the connected sub-cylinders 4 and 6, then a surplus of axially directed compressive forces is achieved resulting in that annular contact surface is affected only by compressive stress when the pressure medium is pressurized. Thus, the axially pre-stressing surfaces act as counteracting surfaces which counteract any separating forces in the axial direction at the joint(s) which could lead to pressure vessel failure. In other words, the outermost diameter of each of the axially pre-stressing surfaces 20 and 22 is greater than that of the contact surface at the joint 3, which thereby, in this embodiment, allows the contact surface between the axially connected sub-cylinders to be pre-stressed to such a degree that the joint is only affected by compressive stress.

Consequently, when the pressure medium is pressurized and the pressure vessel is both radially and axially pre-stressed, the contact surface, including the weld, of the connected sub-cylinders 4 and 6 is free from tensile stress in all directions.

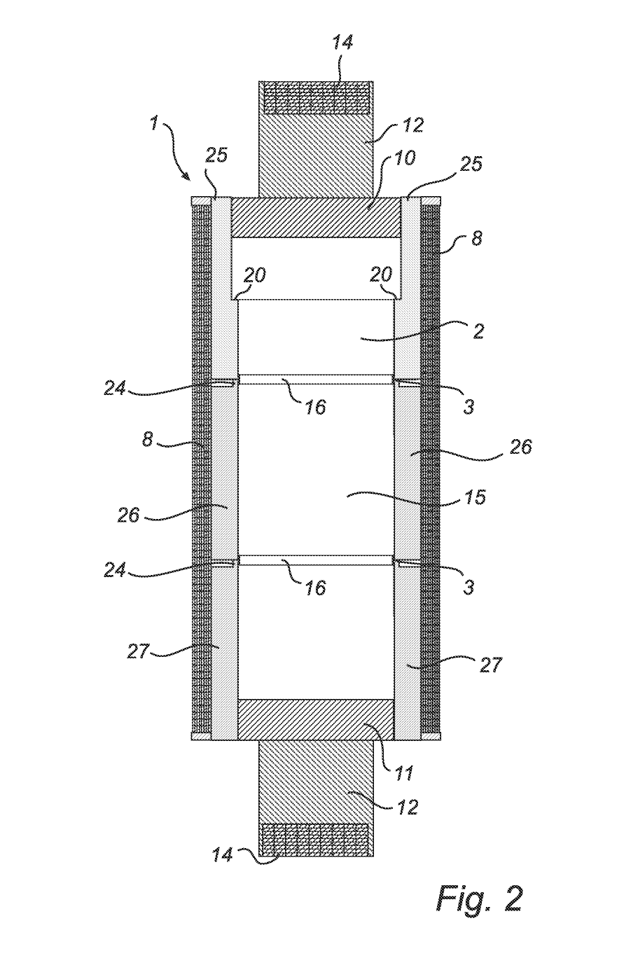

FIG. 2 is a schematic cross section view of the pressure vessel 1 according to another embodiment of the invention. Similar to FIG. 1, the pressure vessel 1 comprises a pressure vessel cylinder 2 but comprises three connected sub-cylinders 25, 26 and 27. The pressure vessel cylinder 2 is closed at the ends by lids 10 and 11 which are held in place by a framework 12. The pressure vessel cylinder 2 together with end lids 10 and 11 encloses a pressure chamber 15, which is arranged to accommodate the articles together with the pressure medium.

The outer envelope surface of the pressure vessel cylinder 2 is provided with a pre-stressing means in the form of a package of wound steel bands 8. The bands are wound tightly radially around the envelope surface of the pressure vessel cylinder 2 to provide a radial compressive stress in the pressure vessel wall. The band is wound in a helical manner from one end of the cylinder to the other and back. The bands have a rectangular cross-sectional shape and are wound edge to edge. Each winding from one end to the other forms a separate pre-stressing layer, and the entire pre-stressing means comprise several layers of wound steel bands.

The framework 12 is also provided with a package of wound steel bands 14 to assist the framework 12 in taking up axial loads. To open the pressure vessel 1, the framework 12 is moved in the direction perpendicular to the axial direction of the pressure vessel cylinder 2, whereby a lid 10, 11 can be removed giving access to the inner side, i.e. the pressure chamber, of the pressure vessel cylinder 2.

The three sub-cylinders 25, 26 and 27 are axially connected by two welds 16 running along the inner wall of the pressure vessel cylinder 2, thereby providing a sealing arrangement which seals the joints 3.

The sub-cylinder 25 is provided with an axially pre-stressing means by means of an axially pre-stressing surface 20. This axially pre-stressing surface is an annular surface along the inner wall of the sub-cylinders 25. The axially pre-stressing surface 20 is arranged for taking up axial forces exerted by the pressure medium when pressurized. In the embodiment of FIG. 2, the other co-operating axially pre-stressing surface is arranged to take up an external force which is transferred to the joint 3 via the sub-cylinder 27. Various arrangements may be used to exert a force on the external axially pre-stressing surface. In the embodiment shown in FIG. 2, the co-operating axially pre-stressing surface of the pair of axially pre-stressing surfaces is provided on portion of the sub-cylinder 27 that is not in contact with pressure medium when pressurized. This external axially pre-stressing surface is arranged externally from the pressure chamber, i.e. the surface is not part of the inner wall of the pressure chamber.

In an alternative embodiment the pressure vessel may be closed in one end and closable with a closure lid in the other end. In such a case, one axially pre-stressing surface is arranged outside the pressure chamber. Alternatively, the axial pre-stressing means may also be arranged outside the pressure vessel, whereby the pressure vessel is free from axially pre-stressing surfaces on the inside of the wall of sub-cylinders.

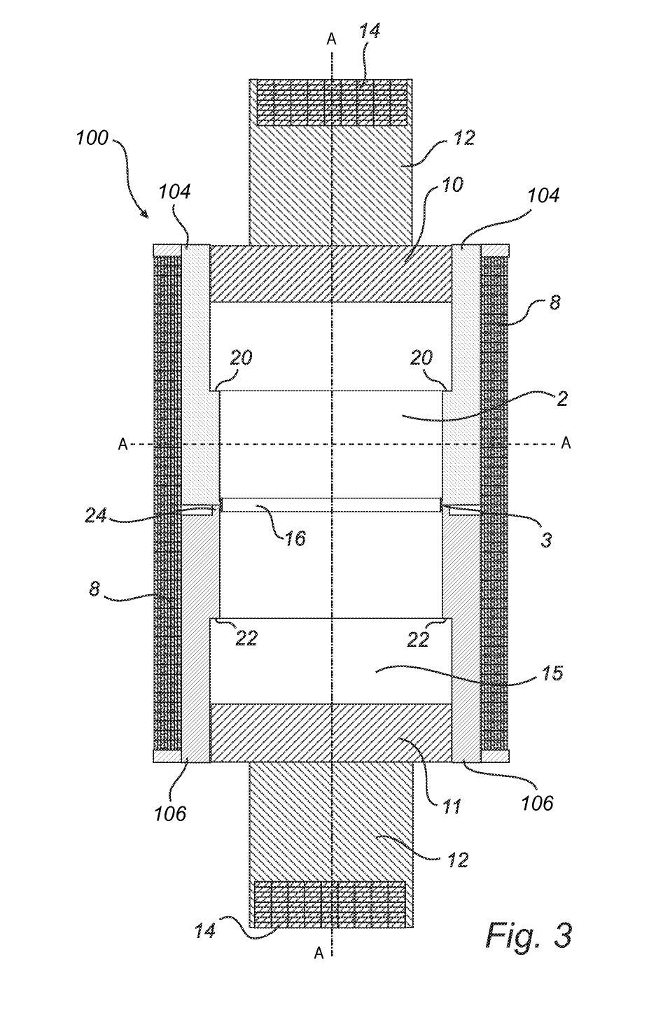

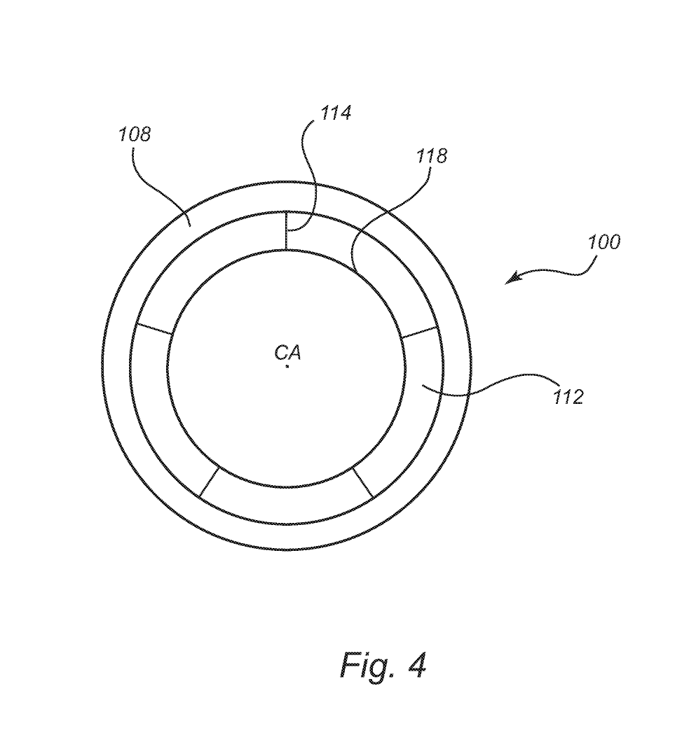

Turning now to FIGS. 3 and 4, a further embodiment of the present invention will be discussed. Anyone of embodiments discussed herein and illustrated in the appended figures may advantageously be combined with anyone of the embodiments described the co-pending application “Pressure vessel and high-pressure press” by the same applicant, which hereby are incorporated herein by reference. In FIGS. 3 and 4, one conceivable embodiment of such combination is schematically illustrated. FIG. 4 is a schematic cross-sectional view of the pressure vessel cylinder shown in FIG. 3 along a cross-section indicated with the line A-A in FIG. 3. The same or corresponding features described in connection with the embodiments shown in FIG. 1 or 2 will be denoted with the same reference numerals in FIGS. 3 and 4 and descriptions thereof or their function will be omitted below.

A pressure vessel cylinder 100 comprises two connected sub-cylinders 104 and 106, wherein each sub-cylinder 104 and 106, in turn, comprises one or more cylinder segments 112 formed to a cylinder in accordance with any one of the embodiments disclosed herein. In this illustrated embodiment of the present invention, each sub-cylinder 104, 106 comprise five cylinder segments 112 arranged to form the respective cylinders 104, 106. However, it is of course conceivable to construct a sub-cylinder of, for example, one cylinder segment or four cylinder segments. Thus, is in embodiment the cylinder body or pressure vessel cylinder 100 comprises ten cylinder segments or wall sections 112, five in each sub-cylinder 104, 106. At adjacent longitudinal edges of the cylinder segments 112 are joints 114. Each interconnection/joint 114 between the segments 112 lie essentially in parallel with the cylinder axis CA and extend the entire sub-cylinder length. Moreover, when assembled together the inner surfaces 118 of the cylinder wall segments 112 define a pressure chamber 15. Preferably, the sub-cylinders 104, 106 are formed first in accordance with the description in the co-pending application, which entails that the sub-cylinders 104, 106 thereafter can be assembled in accordance with the description herein to form the pressure vessel cylinder 2.

Although an exemplary embodiment of the present invention has been shown and described, it will be apparent to those having ordinary skill in the art that a number of changes, modifications, or alterations to the invention as described herein may be made. Thus, it is understood that the above description of the invention and the accompanying drawing is to be regarded as a non-limiting example thereof and that the scope of the protection is defined by the appended claims.

1-13. (canceled)

14. A pressure vessel for isostatic pressing comprising:
at least two sub-cylinders axially connected to form a force absorbing pressure vessel cylinder for enclosing a pressure medium during the isostatic pressing, with the axially connected sub-cylinders being welded or brazed along at least one joint of the at least two connected sub-cylinders;
axially pre-stressing means arranged for exerting axial compressive forces on the sub-cylinders for attaining axial compressive stress at the at least one joint when the pressure medium is pressurized, with the axially pre-stressing means comprising at least one pair of axially pre-stressing surfaces provided on either side of the at least one joint for taking up axial forces exerted thereon when the pressure medium is pressurized, and with the axially pre-stressing surfaces being arranged for transferring the axial forces via a wall of the sub-cylinders to the at least one joint such that an axial compressive stress at the at least one joint is attained; and
radially pre-stressing means arranged for exerting radial compressive forces on the sub-cylinders for attaining tangential compressive stress at the at least one joint when the pressure medium is pressurized.

15. The pressure vessel according to claim 14, wherein the axially pre-stressing means comprises only one pair of axially pre-stressing surfaces, and with first and second surfaces of the pair of the axially pre-stressing surfaces being arranged on first and second end sub-cylinders, respectively, such that the at least one joint is situated between the pair of axially pre-stressing surfaces.

16. The pressure vessel according to claim 14, wherein the first axially pre-stressing surface is arranged on an inner wall of the first end sub-cylinder and the second axially pre-stressing surface is arranged on an outer wall of the second end sub-cylinder, such that the first axially pre-stressing surface takes up internal, axial forces by the pressure medium when the pressure medium is pressurized and the second outer surface takes up external, axial forces by an external force outside the pressurized volume.

17. The pressure vessel according to claim 15, wherein the axially pre-stressing surfaces are arranged on an outer wall of the sub-cylinders, such that the axially pre-stressing surfaces takes up external, axial forces by an external force outside the pressurized volume.

18. The pressure vessel according to claim 15, wherein the axially pre-stressing surfaces are arranged on an inner wall of the sub-cylinders.

19. The pressure vessel according to claim 14, wherein the axially pre-stressing means comprises one pair of axially pre-stressing surfaces for each joint, and wherein the axially pre-stressing surfaces are arranged on an inner wall of the sub-cylinders, such that each of the axially pre-stressing surfaces takes up forces exerted by the pressure medium when the pressure medium is pressurized.

20. The pressure vessel according to claim 18, wherein the axially pre-stressing surface is an annular surface on an annular shoulder arranged on the inner cylinder wall of the sub-cylinder.

21. The pressure vessel according to claim 19, wherein the sub-cylinders are in contact via an annular contact surface at the at least one joint, and wherein the annular contact surface has a radial extension which is equal or less than that of the annular surface of the axially pre-stressing surface.

22. The pressure vessel according to claim 20, wherein at least one end of a first and second connected sub-cylinder ends at the at least one joint has a cylinder wall end provided with a step-like, annular end surface in contact with the other sub-cylinder end of the first and second connected sub-cylinder ends, such that the step-like, annular end surface defines the annular contact surface which the sub-cylinders are in contact at the at least one joint.

23. The pressure vessel according to claim 14, wherein the radially pre-stressing means is provided around the envelope surface of the pressure vessel cylinder.

24. The pressure vessel according to claim 14, wherein the axially connected sub-cylinders are welded or brazed along the at least one joint on the inner wall of the sub-cylinders.
